(19) United States
(12) Patent Application Publication
(10) Pub. No.: US 2006/0262393 A1
(43) Pub. Date: Nov. 23, 2006

(54) METHOD OF MANUFACTURING A MICROLENS, MICROLENS, OPTICAL FILM, SCREEN FOR PROJECTION, PROJECTOR SYSTEM, ELECTRO-OPTICAL DEVICE, AND ELECTRONIC APPARATUS

(75) Inventor: Naoyuki Toyoda, Suwa (JP)

Correspondence Address: HARNESS, DICKEY & PIERCE, P.L.C., P.O. BOX 828, BLOOMFIELD HILLS, MI, 48303, US

(73) Assignee: Seiko Epson Corporation, Tokyo (JP)

(21) Appl. No.: 11/382,740

(22) Filed: May 11, 2006

(30) Foreign Application Priority Data
May 19, 2005 (JP) 2005-146467

(51) Int. Cl. G03B 21/60

(52) U.S. Cl. 359/456

(57) ABSTRACT

A method of forming a microlens such that a convex microlens is formed on a base, the method comprises: placing a first droplet composed of an etchant on the base and forming a concave on the base by etching; placing a second droplet composed of a lens material on the concave; and curing the second droplet to form the microlens.

### BACKGROUND OF THE INVENTION

1. Technical Field

This invention relates to a method of manufacturing a microlens, a microlens, an optical film, a screen for projection, a projector system, an electro-optical device, and an electronic apparatus.

2. Related Art

Various types of display device (electro-optical devices) are provided with color filters to permit color display. In these color filters, dot-like filter elements of red (R), green (G), and blue (B) colors are disposed in a predetermined arrangement such as so-called stripe arrangement, delta arrangement, or mosaic arrangement on a substrate made of, for example, glass, plastic, or the like.

In some types of display device, taking an electro-optical device such as a liquid crystal device or electroluminescent (EL) device as an example, display dots whose optical states can independently be controlled are arranged on a substrate made of glass, plastic, or the like. In this case, liquid crystal or an EL light emitting part is provided in each display dot. As the arrangement of display dots, arrangement in a matrix lattice (dot matrix), for example, is common.

In the display device on which color display is permitted, display dots (liquid crystal or EL light emitting parts) corresponding to, for example, R, G, and B colors mentioned above are usually formed and, for example, three display dots corresponding to all the colors constitute one pixel. By controlling the gradation of each of plural display dots included in one pixel, color display is made possible.

For liquid crystal devices, there are techniques of placing microlenses in a backlight for a liquid crystal display incorporated in a liquid crystal device so as to efficiently collect light from a light source for lighting of the backlight to a liquid crystal element. Many techniques for forming a microlens by using a droplet discharge method have been reported (for example, JP-A-2005-62507, which is an example of related art). In formation of a microlens by a droplet discharge method, the curvature and aspect ratio are generally determined by the contact angle of a microlens droplet to a substrate. Since it is difficult to accumulate droplets higher than the contact angle, the effect of pinning (keeping a droplet in the step part) utilizing a bank or the like is required to obtain a high aspect ratio.

For example, as disclosed in JP-A-2003-258380, which is a first related art example, methods such as forming a bank so as to surround a lens formation section by photolithography or the like have been employed. For example, as disclosed in JP-A-2001-141906, which is a second related art example, a method of utilizing patterning of a lyophobic film instead of a bank, and the like also have been proposed. For example, as disclosed in JP-A-2004-338274 and JP-A-2004-341315, which are third and fourth related art examples, respectively, methods such as forming a base by photolithography or the like have also been proposed.

These methods, however, include the exposure process and the development process in their manufacturing processes, and therefore the use of a mask in the exposure process and the use of a developer in the development process result in failing to make the manufacturing processes efficient. Namely, these methods have not taken full advantage of the merits of droplet discharge methods.

### SUMMARY

An advantage of some aspects of the invention is to provide a method of manufacturing a microlens that is manufactured by a more simple method, a microlens with good optical characteristics, an optical film, a screen for projection, a projector system, an electro-optical device, and an electronic apparatus.

According to an aspect of the invention, a method of forming a microlens such that a convex microlens is formed on a base comprises: placing a first droplet composed of an etchant on the base and forming a concave on the base by etching; placing a second droplet composed of a lens material on the concave; and curing the second droplet to form the microlens.

According to this aspect of the invention, when a first droplet composed of an etchant is placed on the base, a concave is formed on the base by the effect of the etchant. By placing and curing a second droplet composed of a lens material on the concave, a microlens can be formed. Accordingly, a microlens can be formed by a method using a droplet discharge technique, and thus exposure and development processes are not required, making operations efficient.

According to another aspect of the invention, a method of forming a microlens such that a convex microlens is formed on a base comprises: forming a film composed of a bank material on the base; placing a first droplet composed of an etchant on the film and forming a concave by etching the film; placing a second droplet composed of a lens material on the concave; and curing the second droplet to form the microlens.

According to this aspect of the invention, when a first droplet composed of an etchant is placed on a film composed of a bank material, a concave is formed on the film by the effect of the etchant. By placing and curing a second droplet composed of a lens material on the concave, the lens material is unlikely to overflow, thereby enabling formation of a microlens with high curvature and aspect ratio. Furthermore, a microlens can be formed by a method using a droplet discharge technique, and thus exposure and development processes are not required, making operations efficient.

According to a further aspect of the invention, a method of forming a microlens such that a convex microlens is formed on a base comprises: forming a film composed of a bank material on the base; performing a lyophobic treatment for changing wettability of the film; placing a first droplet composed of an etchant on the film and forming a concave by etching the film; placing a second droplet composed of a lens material on the concave; and curing the second droplet to form the microlens.

According to this aspect of the invention, when a lyophobic treatment for changing wettability of a film is performed, for example, the surface of the film is lyophobic, and therefore a droplet of a lens material as the second droplet is likely to be repelled and is unlikely to overflow, thereby being likely to be in place in the concave. As a result, a microlens with less variations can be formed.

In this case, the method of forming a microlens may include a process of drying the first droplet after a process of forming the concave.

According to this aspect of the invention, when a first droplet (etchant) is dried after a concave is formed, a solute solved by the etchant accumulates so as to protrude on the outside of the concave due to coffee-stain phenomenon, so that a protrusion higher than the film is formed to be circular in the outside of the concave, and therefore a second droplet composed of a lens material is unlikely to overflow from the protrusion when placed in the concave, making it easy to place a large amount of lens material. Thus, a microlens with high curvature and aspect ratio can be formed.

According to a microlens according to the invention, it is manufactured by the above-described method of manufacturing a microlens.

In this case, a microlens with high curvature and aspect ratio can be provided by a simple manufacturing method.

According to a still further aspect of the invention, an optical element comprises: a base; a convex microlens formed on the base; and a concave formed by placing a first droplet composed of an etchant on the base and etching the base; wherein the microlens is formed by curing a second droplet composed of a lens material placed on the concave.

According to this aspect of the invention, since the microlens with high curvature and aspect ratio is formed by a simple manufacturing method, an optical element having a good diffusion capability or light collecting capability can be provided.

According to an optical film of the invention, it is provided with a base and the above-described microlens formed on the base that is composed of an optical transparent sheet or an optical transparent film.

In this case, since the microlens that exhibits a high diffusion effect is formed on the above-described optical transparent film by a simple manufacturing method, an optical film having a good diffusion capability can be provided.

According to a screen for projection of the invention, it is provided with a scattering film to scatter light or a diffusion film to diffuse the light placed at a light-incident side or a light-output side, wherein the above-described optical film is used for at least one of the scattering film and the diffusion film.

In this case, the optical film having a good diffusion capability and a good scattering capability is used, a high resolution screen for projection with high brightness and contrast can be provided.

According to a projector system of the invention, it is provided with a screen and a projector, wherein the above-described screen for projection is provided as the screen.

In this case, since a high resolution screen for projection is provided, a high resolution projector system can be provided.

According to a backlight of the invention, it is provided with a light source, a light guiding plate, and a diffusion board, wherein the above-described optical element is provided as the diffusion board.

In this case, since the diffusion board has a microlens exhibiting a high diffusion effect formed thereon, a backlight that can exhibit a good diffusion capability can be provided.

According to an electro-optical device of the invention, it is provided with the above-described backlight.

In this case, since the electro-optical device is provided with the backlight that can exhibit a good diffusion capability, an electro-optical device with good contrast can be provided.

According to an electronic apparatus of the invention, it is provided with the above-described electro-optical device.

In this case, since the electro-optical device with good contrast is provided, a high resolution electronic apparatus can be provided.

### BRIEF DESCRIPTION OF THE DRAWINGS

The invention will be described with reference to the accompanying drawings, wherein like numbers refer to like elements.

FIG. 1 is a schematic perspective view for illustrating the whole structure of a droplet discharge device.

FIG. 2 is a partial sectional view for partially illustrating the main part of the droplet discharge device.

FIGS. 3A to 3E are sectional views for illustrating processes of manufacturing a microlens in a first embodiment.

FIG. 4 is a schematic flow chart for illustrating procedures of the processes of manufacturing a microlens.

FIGS. 5A to 5G are sectional views for illustrating processes of manufacturing a microlens in a second embodiment.

FIG. 6 is a schematic flow chart for illustrating procedures of the processes of manufacturing a microlens.

FIGS. 7A to 7C show concaves formed by dissolution etching; FIGS. 7A, 7B, and 7C are views for illustrating a concave after one droplet falls, a concave after three droplets fall, and a concave after eight droplets fall, respectively.

FIGS. 8A to 8H are sectional views for illustrating processes of manufacturing a microlens in a third embodiment.

FIG. 9 is a schematic flow chart for illustrating procedures of the processes of manufacturing a microlens.

FIG. 10 is a view for illustrating an example of the diffusion board.

FIG. 11 is a view for illustrating an example of the backlight.

FIG. 12 is a view for illustrating a specific example of the liquid crystal display.

FIGS. 13A and 13B are schematic perspective views for illustrating examples of the optical film.

FIG. 14 is a schematic sectional view for illustrating an example of the screen for projection.

FIG. 15 is a schematic structure view for illustrating an example of the projector system.

FIG. 16 is a view illustrating a cellular phone as the electronic apparatus.

### DESCRIPTION OF THE EMBODIMENTS

Embodiments of the invention will now be described.

Embodiments of a microlens and a microlens manufacturing method according to the invention will be mentioned and described in detail with reference to the accompanying drawings. Description will be given through an example of a substrate in which a function liquid is applied onto a base substance by a droplet discharge means. Prior to description of characteristic structures and methods of the invention, a base, a droplet discharge method, a droplet discharge device, a surface treatment method, a bank material, and a microlens material that are used in the droplet discharge means will be described sequentially.

Base

Various types of material such as Si wafer, quartz glass, glass, plastic films, and metal boards can be used as the base in the invention. The substrate that is made of the material mentioned above and which has a semiconductor film, a metal film, a dielectric film, an organic film, or the like formed thereon as the underlying layer may also be used as the base.

Droplet Discharge Method

Examples of discharge techniques of the droplet discharge method include an electrification control method, a pressure vibration method, an electromechanical conversion method, an electrothermal conversion method, and an electrostatic suction method. As used herein, the electrification control method is a method in which a charge electrode applies a charge to a material and the flying direction of the material is controlled by a deflecting electrode, so that the material is discharged from a discharge nozzle. In the pressure vibration method, a ultrahigh pressure of about 30 kg/cm² is applied to a material so that the material is discharged to the nozzle tip side; if no control voltage is applied to a material, the material moves straight to be discharged from the discharge nozzle, whereas if a control voltage is applied, electrostatic repulsion occurs among particles of the material, and the material is scattered not to be discharged from the discharge nozzle. The electromechanical conversion method utilizes the property that a piezo element (a piezoelectric element) deforms when receiving a pulsed electrical signal. Deformation of the piezo element applies pressure through a flexible member to a space where the material is contained so as to eject the material from the space and discharge it from the discharge nozzle.

In the electrothermal conversion method, the material is rapidly vaporized to create bubbles by a heater provided in the space where the material is contained, and the material in the space is ejected by the pressure of the bubbles. In the electrostatic suction method, a small amount of pressure is applied to the inside of the space where the material is contained to form a meniscus of the material at the discharge nozzle, and in this state electrostatic suction is applied to draw out the material. Additionally, other techniques such as a method of utilizing changes in viscosity of a fluid depending on the electric field and a method of spraying a droplet by a spark can be applied. The droplet discharge method has advantages in that it has little waste in material use and a desired amount of material can be accurately placed at a desired location. The mass of one droplet of liquid material discharged by the droplet discharge method is, for example, 1 to 300 nanograms.

Droplet Discharge Device

An example of the droplet discharge device to discharge a liquid material by using the above-described droplet discharge method will next be described. In this embodiment, description will be given using a droplet discharge device for discharging a droplet from the droplet discharge head to a substrate by using a droplet discharge method.

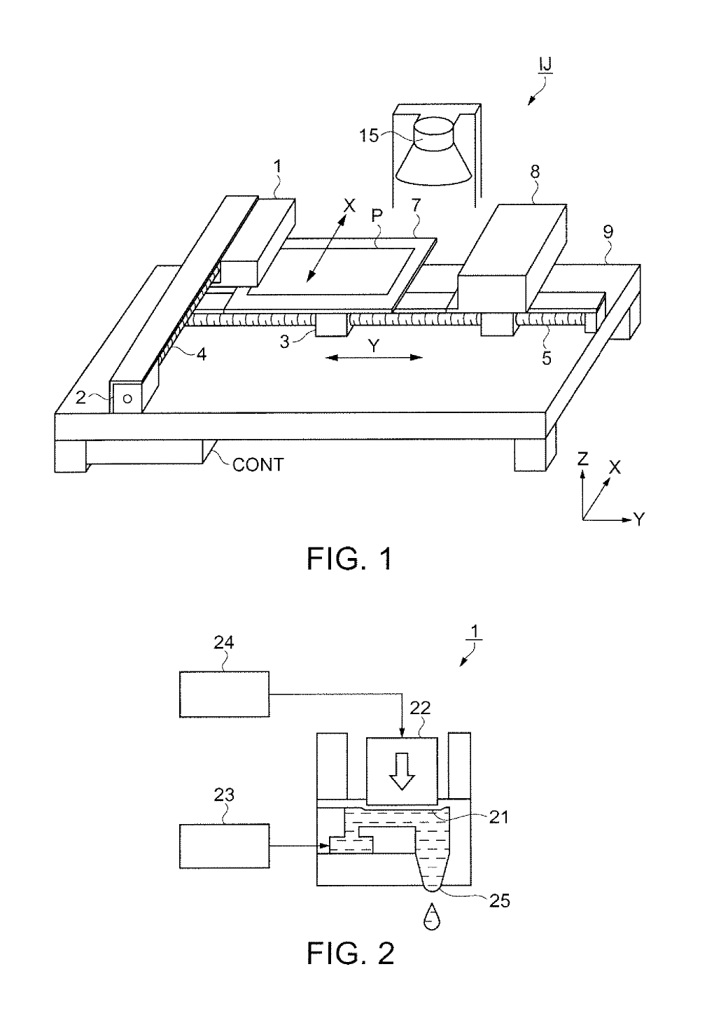

FIG. 1 is a perspective view illustrating a schematic structure of a droplet discharge device IJ.

The droplet discharge device IJ includes a droplet discharge head 1, an X axis direction drive shaft 4, a Y axis direction guide axis 5, a control unit CONT, a stage 7, a cleaning mechanism 8, a base table 9, and a heater 15.

The stage 7 supports a substrate P onto which a liquid material is placed by the droplet discharge device IJ, and includes a fixing mechanism (not shown) to fix the substrate P to the normal position.

The droplet discharge head 1 is a droplet discharge head of multi-nozzle type having a plurality of discharge nozzles, and its longitudinal direction coincides with the X axis direction. The plurality of discharge nozzles spaced at regular intervals are provided on the undersurface of the droplet discharge head 1. A liquid material is discharged from the discharge nozzle of the droplet discharge head 1 to the substrate P supported by the stage 7.

An X axis direction drive motor 2 is connected to the X axis direction drive shaft 4. The X axis direction drive motor 2 is a stepping motor or the like and rotates the X axis direction drive shaft 4 when a drive signal in the X axis direction is supplied from the control unit CONT. When the X axis direction drive shaft 4 is rotated, the droplet discharge head 1 is moved in the X axis direction.

The Y axis direction guide axis 5 is fixed not to move with respect to the base table 9. The stage 7 has a Y axis direction drive motor 3. The Y axis direction drive motor 3 is a stepping motor or the like and moves the stage in the Y axis direction when a drive signal in the Y axis direction is supplied from the control unit CONT.

The control unit CONT supplies a voltage for controlling discharge of a droplet to the droplet discharge head 1. It also supplies a drive pulse signal for controlling movement of the droplet discharge head 1 in the X axis direction to the X axis direction drive motor 2 and a drive pulse signal for controlling movement of the stage 7 in the Y axis direction to the Y axis direction drive motor 3.

The cleaning mechanism 8 cleans the droplet discharge head 1. The cleaning mechanism 8 is provided with a drive motor in the Y axis direction (not shown). The cleaning mechanism is driven to transfer along the Y axis direction guide axis 5 by the Y axis direction drive motor. The transfer of the cleaning mechanism 8 is also controlled by the control unit CONT.

The heater 15 is used here as a means for heat treatment of the substrate P by lamp annealing, and performs evaporation and drying of a solvent contained in a liquid material provided on the substrate P. Power on and off of the heater 15 is also controlled by the control unit CONT.

The droplet discharge device IJ discharges droplets to the substrate P from a plurality of discharge nozzles arranged in the X axis direction on the undersurface of the droplet discharge head 1 while the droplet discharge head 1 and the stage 7 supporting the substrate P are scanned with each other.

FIG. 2 is a diagram for explaining the principle of discharging a liquid material by a piezo method.

As shown in FIG. 2, a piezo element 22 is placed adjacent to a liquid chamber 21 containing a liquid material. A liquid material is supplied to the liquid chamber 21 through a liquid material supply system 23 including a material tank that contains the liquid material. The piezo element 22 is connected to a drive circuit 24, through which a voltage is applied to the piezo element 22 so as to deform the piezo element 22. The deformation of the piezo element 22 causes deformation of the liquid chamber 21, and thereby a liquid material is discharged from a discharge nozzle 25. In this case, the deformation amount of the piezo element 22 is controlled by varying the applied voltage, and its deformation velocity of the piezo element 22 is controlled by varying the frequency of the applied voltage. The droplet discharge by a piezo method does not add heat to a material, and therefore has an advantage of having little effect on the composition of the material.

The droplet discharge device described above can be used in the arranging and manufacturing methods according to the invention, but the invention is not limited to this; any devices capable of discharging a droplet and landing the droplet at a predetermined landing position can be used.

Surface Treatment Method

As the surface treatment method in this embodiment, a method of forming an organic thin film on a surface of the substrate, a plasma treatment method, and the like can be employed as the lyophobic treatment for the purpose of controlling the contact angle of a droplet. In order to make the surface lyophobic properly, it is preferable to perform cleaning as the preparation process. For example, ultraviolet light cleaning, ultraviolet light and ozone cleaning, plasma cleaning, acid or alkali cleaning, and other cleanings can be employed.

In the method of forming an organic thin film as the lyophobic treatment, an organic thin film is formed of organic molecules such as silane compounds or surface-active agents on the surface of a substrate on which a wiring pattern is to be formed.

The organic molecule for treating the surface of the substrate includes a functional group that can be physically and chemically bonded to the substrate and, at the opposite side thereof, another functional group that modifies the surface nature of the substrate (controls the surface energy) such as a lyophilic group or a lyophobic group, and is bonded to the substrate to form an organic thin film and ideally to form a monomolecular film. Among such organic molecules, an organic molecule with an organic constitution, which is carbon normal chain or branched carbon chain, combining the substrate-bonding functional group with the surface-modifying functional group is bonded to the substrate and is self-assembled to form a dense self-assembled film.

The term “self-assembled film” as used herein refers to a film that includes a binding functional group capable of reacting with constituent atoms of the underlying layer of the substrate or the like and in addition a normal chain and an aromatic ring structure, and which is formed by orienting a compound having very strong orientation due to van der Waals interaction between normal chains and π-π stacking between aromatic rings. Since the self-assembled film is formed by orienting mono-molecules, the film thickness can be made very thin and furthermore a uniform film is formed at molecular level. In other words, the same molecules are positioned on the surface of the film, enabling the film surface to be provided with uniform and excellent lyophobicity or lyophilicity.

As the compound having such strong orientation as mentioned above, for example, the following silane compound as expressed by the general formula R¹SiX¹ₐX²₍₃₋ₐ₎ can be used. In the formula, R¹ represents an organic group; X¹ and X² represent —OR², —R², and —Cl; R² included in X¹ and X² represents an alkyl group having a carbon number of 1 to 4; and a is an integer ranging from 1 to 3.

The silane compound represented by the general formula R¹SiX¹ₐX²₍₃₋ₐ₎ is one in which silane atom is replaced by an organic group and remaining bond groups are replaced by alkoxy groups, alkyl groups, or chlorine groups. Examples of the organic group R¹ include phenyl group, benzyl group, phenethyl group, hydroxyphenyl group, chlorophenyl group, aminophenyl group, naphthyl group, anthranyl group, pyrenyl group, thienyl group, pyrrolyl group, cyclohexyl group, cyclohexenyl group, cyclopentyl group, cyclopentenyl group, pyridinyl group, methyl group, ethyl group, n-propyl group, isopropyl group, n-butyl group, isobutyl group, sec-butyl group, tert-butyl group, n-hexyl group, n-octyl group, n-desyl group, n-octadecyl group, chloromethyl group, methoxyethyl group, hydroxyethyl group, aminoethyl group, cyano group, mercaptopropyl group, vinyl group, allyl group, acryloxyethyl group, methacryloxyethyl group, glycidoxypropyl group, and acetoxy group.

The alkoxy group or chlorine group of X¹ is a functional group for forming Si—O—S bonding or the like, and is hydrolyzed with water to be removed as alcohol or acid. Examples of the alkoxy group include methoxy group, ethoxy group, n-propoxy group, isopropoxy group, n-butoxy group, isobutoxy group, sec-butoxy group, and tert-butoxy group.

The number of carbons of R² preferably ranges from 1 to 4 because the alcohol has relatively low molecular weight to be easily removed so that reduction in density of a film formed can be suppressed.

As representative examples of lyophobic silane compounds expressed by the general formula R¹SiX¹ₐX²₍₃₋ₐ₎, fluorine-containing alkyl silane compounds are mentioned. In particular, the compounds having a structure in which R¹ is represented by a perfluoroalkyl structure CₙF₂ₙ₊₁, where n is an integer from 1 to 18, are representative. By using fluorine-containing alkyl silane compounds, a self-assembled film is formed with compounds being oriented so that fluoroalkyl groups are positioned on the surface of the film. As a result, the film surface can be provided with uniform lyophobicity.

Silane compounds having a fluoroalkyl group and a perfluoroalkyl ether structure are generally referred to as “FAS”. These compounds may be used alone or in combination of two or more kinds thereof. In addition, adhesion to the substrate and good lyophobicity can be obtained by using FAS.

In addition to silane compounds, surface-active agents as represented by the general formula R¹Y¹ mentioned below can also be used as the compounds having strong orientation. In R¹Y¹, R¹ represents a hydrophobic organic group, and Y¹ represents a hydrophilic polar group such as —OH, —(CH2CH2O)nH, —COOH, —COOA, —CONH2, —SO3H, —SO3A.-OSO3H, —OSO3A, —PO3H2, —PO3A, —NO2, —NH2, —NH3B (ammonium salt), ≡NHB (pyridinium salt), —NX¹₃B (alkylammonium salt), where A represents one or more cations and B represents one or more anions. X¹ means an alkyl group having the same carbon numbers of 1 to 4 as described above.

Surface-active agents represented by the general formula R¹Y¹ are amphiphilic compounds, which are compounds in which a hydrophilic functional group is bonded to a lipophilic organic group R¹Y¹ represents a hydrophilic polar group and is a functional group for bonding or adhesion to the substrate, and an organic group R¹ is lipophilic and lines up on the opposite side of the hydrophilic surface, thereby forming a lipophilic surface on the hydrophilic surface.

As representative examples of lyophobic silane compounds represented by the general formula R¹Y¹, fluorine-containing alkyl surface-active agents are mentioned. In particular, the compounds having a structure in which R¹ is represented by a perfluoroalkyl structure CₙF₂ₙ₊₁ or a perfluoroalkylether structure, where n is an integer from 1 to 18, are representative.

Such surface-active agents having the perfluoroalkyl structure or perfluoroalkylether structure may be used alone or in combination of two or more kinds thereof. In addition, adhesion to the substrate and good lyophobicity can be obtained by using a surface-active agent with a perfluoroalkyl group.

Moreover, alkyl structures without fluorine may be used. Lyophobicity can also be obtained from an ordinary surface-active agent when a dense film is formed by using it.

An organic thin film made of organic molecules such as silane compounds and surface-active agents is formed on the substrate P by containing the above-described raw material compounds and the substrate P in the same sealed container and leaving them at room temperature for about 2 to 3 days. The film is formed on the substrate in about 1 to 3 hours by keeping the entire sealed container at 80 to 140° C. These techniques are formation methods from vapor phase, but a self-assembled film can also be formed from liquid phase. For example, a substrate is immersed in a solution containing a raw material compound for 30 minutes to 6 hours, cleaned, and dried, so that a self-assembled film is formed on the substrate. If a solution containing a raw material compound is heated at 40 to 80° C., a self-assembled film can be formed by immersing the substrate in the solution for 5 minutes to 2 hours.

In the plasma treatment method, plasma is applied to the substrate P at normal pressures or in vacuum. Various types of gas can be employed in consideration of the surface quality or the like of the substrate P on which a wiring pattern is to be formed. Fluorocarbon-based compounds can be preferably used as the treatment gas; for example, tetrafluoromethane, perfluorohexane, perfluorodecane, and the like can be mentioned as the example. The treatment conditions of a plasma treatment method using tetrafluoromethane as the treatment gas (CF₄ plasma treatment method) are: plasma power of 50 to 1000 W, carbon tetrafluoride gas flow rate of 50 to 100 mL/min, a carrying rate of substrate relative to plasma discharge electrode of 0.5 to 1020 mm/sec, and a substrate temperature of 70 to 90° C.

Bank Material

A bank material to be used in the prevention is not particularly limited as long as it can be etched or dissolved after bank formation. Examples of such materials include materials that can be dissolved with a solvent medium after a solution having a resin molten in a solvent is applied, and curing resins such as thermosetting resins and photopolymerizing resins that can be etched.

As the bank material, organic materials such as polyimide, acrylic resins, and novolac resins are typically used. In addition to the above materials, oligomers and polymers such as polyvinyl alcohol, unsaturated polyesters, methylmethacrylate resins, polyethylenes, diallyl phthalate, ethylene propylene diene monomers, epoxy resins, phenol resins, polyurethanes, melamine resins, polycarbonates, polyvinyl chlorides, polyamides, styrene-butadiene rubber, chloroprene rubber, polypropylenes, polybutylenes, polystyrenes, polyvinyl acetates, polyesters, polybutadienes, polybenzimidazoles, polyacrylonitriles, epichlorohydrins, polysulfides, and polyisoprenes can be employed.

The bank material must not be dissolved in or react to a solution or a resin that is brought into contact with the bank material, and therefore is preferably a curing resin that is cured by light or heat before a microlens material is discharged.

The photopolymerizing resin as described above normally has at least one or more functional groups, and is made by curing a polymer composition having at least monomers and oligomers that perform ionic polymerization or radical polymerization using ions or radicals produced by applying light to a photopolymerization initiator to increase the molecular weight and to form the bridged structure if needed, and the photopolymerization initiator. The functional group mentioned herein refers to an atomic group or a bond style causing a reaction of vinyl group, carboxyl group, amino group, hydroxyl group, epoxy group, or the like.

The thermosetting resin normally has at least one or more functional groups, and is made by curing a polymer composition having at least monomers and oligomers that perform ionic polymerization or radical polymerization using ions or radicals produced by adding heat to a thermal polymerization initiator to increase the molecular weight and to form the bridged structure if needed, and the thermal polymerization initiator. The functional group mentioned herein refers to an atomic group or a bond style causing a reaction of vinyl group, carboxyl group, amino group, hydroxyl group, epoxy group, or the like.

Solutions of resin such as varnish can be employed as the bank material without being cured by light or heat, if a polymer that is excellent in heat resistance, such as polyimide, is dissolved beforehand in the solution and is deposited by drying.

Fine particle dispersion liquids can also be employed because heat resistance and excellent optical transparency can be obtained. Examples of the fine particles for the liquid include fine particles of silica, alumina, titania, calcium carbonate, aluminum hydroxide, acrylic resin, organic silicon resin, polystyrene, urea resin, and formaldehyde condensate. These are used alone or in a mixture of a plurality of kinds thereof. If the fine particles are employed, they are deposited by drying and aggregate, and thereby can be used as a bank. In addition, a photosensitive or thermosensitive surface treatment may be applied to particle surfaces so as to improve adhesion among the particles and between the substrate and the particles.

Typical coating methods can be employed in the process of forming a bank material. Examples of coating methods include various methods such as a dip-coating method, an air knife coating method, a blade coating method, a spray-coating method, a bar coating method, a rod coating method, a roll coating method, a gravure coating method, a size press method, a spin-coating method, a droplet discharge method, and a screen printing method. Since a droplet discharge method is included in the invention, it is preferable to employ a droplet discharge method in the bank formation process.

A minute amount of a fluorinated, silicone, or nonionic surface tension conditioning material can be added to the above-described bank material used in this embodiment as required unless intended functions are impaired. These surface tension conditioning materials enable control of wettability of an object to be coated with the bank material, improving the leveling of the coated film, and therefore is useful for prevention of irregularity, orange peel, and the like of the coated film.

If the bank material conditioned in this manner is used in a droplet discharge method, it is preferable that the viscosity be 1 to 50 mPa·s. In application of a solution by a droplet discharge device, if the viscosity is less than 1 mPa·s, the periphery of a nozzle tends to be contaminated by the outflow of a droplet; if the viscosity is greater than 50 mPa·s, the frequency of clogging in nozzle holes increases, so that smooth discharge of a droplet becomes difficult. It is more preferable that the viscosity be 5 to 20 mPa·s.

Furthermore, it is desirable that the surface tension of the bank material conditioned in this manner range from 0.02 to 0.07 N/m. In application of a solution by a droplet discharge device, if the surface tension is less than 0.02 N/m, the wettability of a droplet to a nozzle surface increases, so that the droplet tends to have some fluctuation in flight direction; if the surface tension is greater than 0.07 N/m, the shape of a meniscus is not stable, so that control of the amount and timing of discharging a droplet becomes difficult.

Etchant

An etchant to be used in the invention is not particularly limited as long as it can etch or dissolve a bank or a bank material and is in a liquid state in which it can be discharged as a droplet. As such a material, acid, alkali, and good solvents for bank materials can be mentioned.

As the etchant, normal acid or base can be employed. As the acid mentioned above, protonic acids such as hydrochloric acid, sulfuric acid, phosphorous acid, nitric acid, acetic acid, carbonic acid, formic acid, benzoic acid, chlorous acid, hypochlorous acid, sulfurous acid, hyposulfurous acid, nitrous acid, hyponitrous acid, phosphorous acid, and hypophosphorous acid can be mentioned. Among them, hydrochloric acid, sulfuric acid, phosphorous acid, and nitric acid are preferred.

On the other hand, sodium hydroxide, potassium hydroxide, and calcium hydroxide can be mentioned as the alkali mentioned above. Among them, sodium hydroxide and potassium hydroxide are preferred.

The above-described etchant is strongly corrosive and tends to cause corrosion in a droplet discharge device. It is therefore preferable that the etchant have low concentration. Even in low concentration, the etchant is condensed during drying after the droplet discharge, and thus etching can be performed.

As the good solvents for bank materials, solvents having high solubility for bank materials are sufficient and therefore typical solvent media can be employed. Specific examples thereof include: water; alcohols such as methanol, ethanol, propanol, and butanol; hydrocarbon-based compounds such as n-heptane, n-octane, decane, dodecane, tetradecane, toluene, xylene, cymene, durene, indene, dipentene, tetrahydronaphthalene, decahydronaphthalene, and cyclohexylbenzene; ether-based compounds such as ethylene glycol dimethyl ether, ethylene glycol diethyl ether, ethylene glycol methylethyl ether, diethylene glycol dimethyl ether, diethylene glycol diethyl ether, diethylene glycol methylethyl ether, 1,2-dimethoxyethane, bis(2-methoxyethyl)ether, and p-dioxane; and polar compounds such as propylene carbonate, -butyrolactone, N-methyl-2-pyrrolidone, dimethylformamide, dimethylsulfoxide, cyclohexanone, dichloromethane, chloroform, and tetrahydrofuran.

A minute amount of a fluorinated, silicone, or nonionic surface tension conditioning material can be added to the above-described etchant used in this embodiment as required unless intended functions are impaired. These surface tension conditioning materials enable control of wettability of an object to be coated with the etchant, improving the leveling of the coated film, and therefore is useful for prevention of irregularity, orange peel, and the like of the coated film.

For the etchant conditioned in this manner, it is preferable that the viscosity be 1 to 50 mPa·s. In application of a solution by a droplet discharge device, if the viscosity is less than 1 mPa·s, the periphery of a nozzle tends to be contaminated by the outflow of a droplet; if the viscosity is greater than 50 mPa·s, the frequency of clogging in nozzle holes increases, so that smooth discharge of a droplet becomes difficult. It is more preferable that the viscosity be 5 to 20 mPa·s.

Furthermore, it is desirable that the surface tension of the etchant conditioned in this manner range from 0.02 to 0.07 N/m. In application of a solution by a droplet discharge device, if the surface tension is less than 0.02 N/m, the wettability of a droplet to a nozzle surface increases, so that the droplet tends to have some fluctuation in flight direction; if the surface tension is greater than 0.07 N/m, the shape of a meniscus is not stable, so that control of the amount and timing of discharging a droplet becomes difficult.

Microlens Material

A material constituting a microlens 30 is not particularly limited as long as it is in a liquid state capable of being discharged as a droplet when the droplet is formed and thereafter be able to be cured, and further have a optical transparency capable of functioning as a lens after cured. As such a resin, the resin having the above optical transparency from which a solvent media is removed after a solution having a resin molten in a solvent is applied, and thermoplastic resins, thermosetting resins, photopolymerizing resins, and other various resins can be mentioned. Among them, photopolymerizing resins are preferable, because their curing is easy and rapid, and furthermore a lens formation material and a base material do not reach a high temperature when the resin is cured.

The photopolymerizing resin as described above normally has at least one or more functional groups, and is made by curing a polymer composition having at least monomers and oligomers that perform ionic polymerization or radical polymerization using ions or radicals produced by applying light to a photopolymerization initiator to increase the molecular weight and to form the bridged structure if needed, and the photopolymerization initiator. The functional group mentioned herein refers to an atomic group or a bond style causing a reaction of vinyl group, carboxyl group, hydroxyl group, or the like.

Examples of such monomers and oligomers include ones of unsaturated polyester type, enethiol type, acrylic type, and the like. Among them, acrylic type monomers and oligomers are preferable because of their curing rate and broad options of solid-state properties. Among these acrylic type monomers and oligomers, ones having a monofunctional group can be mentioned as follows: 2-ethyl hexyl acrylate, 2-ethyl hexyl EO adduct acrylate, diethyleneglycol ethoxyl acrylate, 2-hydroxy ethyl acrylate, 2-hydroxypropyl acrylate, caprolactone adduct of 2-hydroxy ethyl acrylate, 2-phenoxy ethyl acrylate, phenoxy diethyleneglycol acrylate, nonylphenol EO adduct acrylate, acrylate of nonylphenol EO adduct caprolactone adducted, 2-hydroxy-3-phenoxypropyl acrylate, tetrahydrofurfuryl acrylate, caprolactone adduct acrylate of furfuryl alcohol, acryloyl morpholine, dicyclopentenyl acrylate, dicyclopentanyl acrylate, dicyclopentenyloxyethyl acrylate, isobonyl acrylate, 4,4-dimethyl-1, acrylate of caprolactone adduct of 3-dioxolane, 3-methyl-5,5-dimethyl-1, and acrylate of caprolactone adduct of 3-dioxolane.

Among the acrylic type monomers and oligomers, multifunctional ones can be mentioned as follows: hexanediol acrylate, neopentyl glycol diacrylate, polyethylene glycol diacrylate, tripropylene glycol diacrylate, hydroxypivalic acid neopentyl glycol ester, caprolactone adduct diacrylate of hydroxypivalic acid neopentyl glycol ester, acrylic acid adduct of diglycidyl ether of 1,6-hexanediol, diacrylate of acetal compound of hydroxypivalic aldehyde and trimethylolpropane, 2,2-bis[4-(acryloyloxy diethoxy)phenyl] propane, 2,2-bis [4-(acryloyloxy diethoxy)phenyl] methane, diacrylate of hydrogenated bisphenol ethylene oxide adduct, tricyclodecane dimethanol diacrylate, trimethylolpropane triacrylate, pentaerythritol triacrylate, trimethylolpropane propylene oxide adduct triacrylate, glycerin propylene oxide adduct triacrylate, dipentaerithritol hexacrylate pentacrylate mixture, caprolactone adduct acrylate of dipentaerithritol, tris(acryloyloxy ethyl) isocyanurate, 2-acryloyloxy ethyl phosphate.

The resin having optical transparency mentioned above may be provided beforehand with light diffusion fine particles in mixed dispersion. Examples of light diffusion fine particles include fine particles of silica, alumina, titania, calcium carbonate, aluminum hydroxide, acrylic resins, organic silicon resins, polystyrenes, urea resins, and formaldehyde condensates. These are used alone or in a mixture of a plurality of kinds thereof. In order for light diffusion fine particles to achieve full light diffusion, if the fine particles are optical transparent, their refractive index is needed to have a sufficient difference from that of the resin having optical transparency. Therefore, if the light diffusion fine particles are optical transparent, they are suitably selected and used in accordance with the resin having optical transparency to be used so as to satisfy this condition.

Such light diffusion fine particles are adjusted to be in a liquid state in which they can be discharged from the droplet discharge head 1 by dispersing them beforehand to the optical transparent resin. At this point, it is preferable to enhance the dispersion of the light diffusion fine particles to the optical transparency resin by coating the surface of light diffusion fine particles with a surface-active agent or with a molten resin. These treatments can add fluidity for making the discharge from the droplet discharge head 1 smooth to the optical transparent resin in which the light diffusion fine particles have been dispersed. In addition, the surface-active agent used for the surface treatment is suitably selected from cation-based, anion-based, nonion-based, amphoteric, silicon-based, fluorocarbon resin-based, and other agents in accordance with the kind of light diffusion fine particles.

As such light diffusion fine particles, it is preferable to use fine particles having a particle size not less than 5 nm nor more than 1000 nm. It is more preferable to use fine particles having a particle size not less than 200 nm nor more than 500 nm. In these ranges, a particle size of 200 nm or more will ensure good light diffusion, and a particle size of 500 nm or less allows good discharge from nozzles of the droplet discharge head 1.

In the microlens 30 obtained from an optical transparent resin provided with light diffusion fine particles in mixed dispersion as described above, functions are made complex due to the provision of light diffusion fine particles, and therefore thermoplasticity can be suppressed while more higher diffusion performance is provided. As a result, excellent heat resistance can be obtained.

Resins containing an inorganic component may be employed because heat resistance and excellent optical transparency can be obtained. Specific examples of inorganic components include silicon, germanium, and titanium; resins containing silicon are preferable in terms of ready availability.

As such polymers, polysiloxane, polysilane, and polysilazane are mentioned. These compounds include silicon in the polymer main-chain structure, and are used for forming silicon oxides similar to glass by a chemical reaction using heat, light, a catalytic agent, or the like. The silicon oxides formed in this manner have excellent heat resistance and optical transparency as compared to resins composed of just organic materials, and therefore are preferable for the microlens material.

More specifically, a polysiloxane solution having an alkoxy group is discharged together with a catalytic agent, and then is dried and heated so that the alkoxy group contained in the solution is condensed, enabling a silicon oxide to be obtained. A polysilane solution is discharged, and then is irradiated with ultraviolet rays so that the polysilane contained in the solution is photooxidized, enabling a silicon oxide to be obtained. A polysilazane solution is discharged, and thereafter the polysilazane contained in the solution is hydrolyzed with ultraviolet rays, acid or alkali, or the like and oxidized, enabling a silicon oxide to be obtained.

A minute amount of a fluorinated, silicone, or nonionic surface tension conditioning material can be added to a droplet of the above-described microlens material used in this embodiment as required unless intended functions are impaired. These surface tension conditioning materials enable control of wettability of an object to be coated with the microlens material, improving the leveling of the coated film, and therefore is useful for prevention of irregularity, orange peel, and the like of the coated film.

The viscosity of the droplet of the microlens material conditioned in this manner is preferably 1 to 50 mPa·s. In application of a solution by a droplet discharge device, if the viscosity is less than 1 mPa·s, the periphery of a nozzle tends to be contaminated by the outflow of a droplet; if the viscosity is greater than 50 mPa·s, the frequency of clogging in nozzle holes increases, so that smooth discharge of a droplet becomes difficult. It is more preferable that the viscosity be 5 to 20 mPa·s.

Furthermore, it is desirable that the surface tension of the droplet of the microlens material conditioned in this manner range from 0.02 to 0.07 N/m. In application of a solution by a droplet discharge device, if the surface tension is less than 0.02 N/m, the wettability of a droplet to a nozzle surface increases, so that the droplet tends to have some fluctuation in flight direction; if the surface tension is greater than 0.07 N/m, the shape of a meniscus is not stable, so that control of the amount and timing of discharging a droplet becomes difficult.

### First Embodiment

Microlens Manufacturing Method 1

In this embodiment, an etchant such as acid or alkali in droplet form is discharged from discharge nozzles of the droplet discharge head and is placed on a substrate to which the surface treatment has been applied by using a droplet discharge method, and etching is performed on the substrate to form a concave. Moreover, a microlens material or a droplet containing a microlens material from discharge nozzles of a droplet discharge head to be placed on the concave by a droplet discharge method. A method of forming a microlens having the lens shape controlled by utilizing the concave will be described.

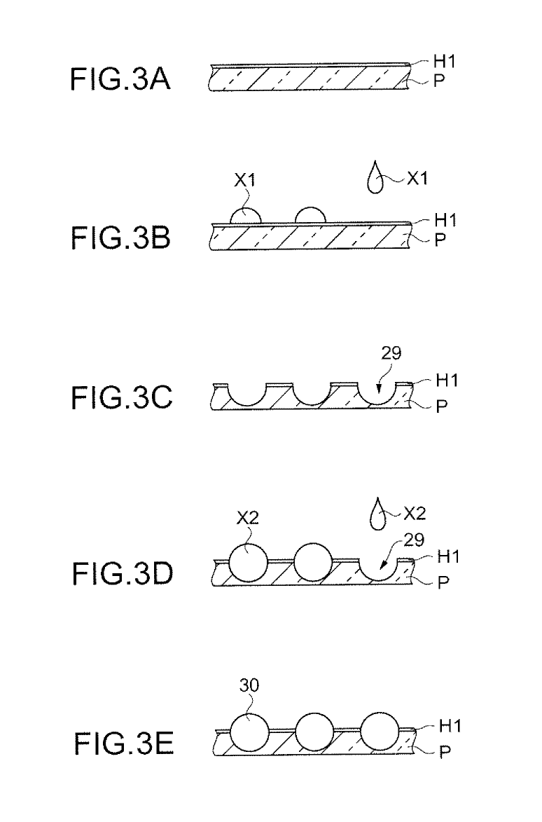

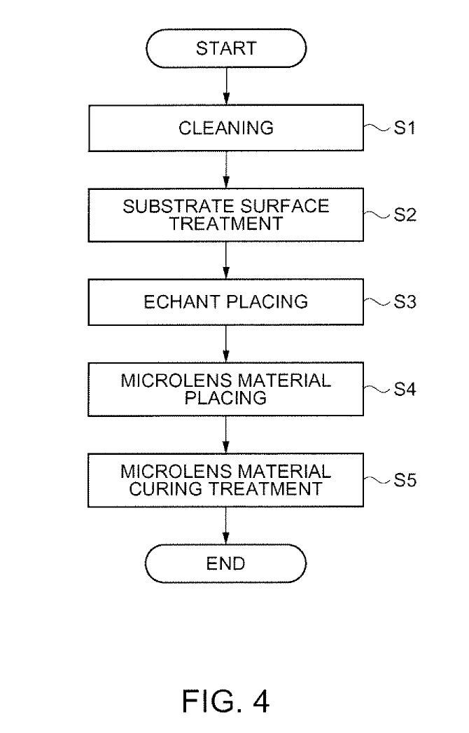

FIGS. 3A to 3E are sectional views for illustrating processes of manufacturing a microlens in the first embodiment. FIG. 4 is a schematic flow chart for illustrating procedures of the processes of manufacturing a microlens.

With reference to FIGS. 3A to 3E and FIG. 4, a method of manufacturing a microlens according to the invention will now be described. In addition, a method of forming a microlens in this embodiment substantially consists of substrate cleaning, a substrate surface treatment, etchant placing, microlens material placing, and microlens material curing. Detailed description on these processes will be given below.

FIGS. 3A to 3E are sectional views for illustrating processes of manufacturing a microlens, and FIG. 4 is a schematic flow chart for illustrating procedures of the processes of manufacturing a microlens.

(Substrate Cleaning)

In step S1 of FIG. 4, the substrate P is cleaned. In order to perform a lyophobic treatment of the substrate P properly, it is preferable to perform cleaning as the pretreatment of this lyophobic treatment. Ultraviolet cleaning, ultraviolet/ozone cleaning, plasma cleaning, acid or alkali cleaning, or the like can be employed as the cleaning method of the substrate P. In addition, the material of the substrate P is, for example, glass that is alkaline and can be etched.

(Substrate Surface Treatment)

In step S2 of FIG. 4, the surface of the substrate P is treated as shown in FIG. 3A. The surface treatment of the substrate P is to make the surface of the substrate P lyophobic so as to obtain a contact angle required for the purpose of reducing the impact diameter of a bank material, which will be the diameter of a lens to be formed. As the method of making the surface of the substrate P lyophobic, a method of forming an organic thin film on the surface of the substrate P, a plasma treatment method, or the like can be employed. In this case, the method of forming an organic thin film is employed. A lyophobic layer H1 is thus provided with lyophobicity.

(Etchant Placing)

In step S3 of FIG. 4, an etchant X1 composed of an acid or alkaline solution as a first droplet is discharged from the droplet discharge head 1 and placed onto a lyophobic layer H1 formed on the substrate P, as shown in FIG. 3B. In addition, a known method disclosed, for example, in JP-A-2003-149831, which is a related art example, is employed as the method of placing the etchant X1. Either one droplet discharged or a plurality of droplets discharged may be defined as one first droplet.

An alkaline liquid is employed as the etchant X1. Examples of the alkaline liquid include water solutions such as sodium hydroxide and potassium hydroxide. The pH of the water solution is preferably 10 or more, more preferably 12 or more, and most preferably 14 or more. If the pH is less than 10, it takes much time to remove a desired portion to be coated with an alkaline liquid until the required depth is reached, and the removal tend to be insufficient. The alkaline liquid is left for 1 minute to several hours on the substrate P after being placed, and thereafter the liquid on the substrate P is etched. It is therefore preferable to add an organic solvent medium, a surface-active agent, or the like of a high boiling point in order not to dry the droplet during these operations. Specific examples of solvent media having a high boiling point include glycerin, ethylene glycol dimethyl ether, ethylene glycol diethyl ether, ethylene glycol methyl ethyl ether, diethylene glycol dimethyl ether, diethylene glycol diethyl ether, and diethylene glycol methyl ethyl ether. Fluorinated, silicone, or nonionic surface tension adjusters are mentioned as the surface-active agent.

The contact angle of the etchant X1 (alkaline liquid) when the etchant X1 (alkaline liquid) is applied to the surface of the substrate P is preferably not less than 30 degrees nor more than 60 degrees. In the case of a contact angle of less than 30 degrees, a droplet is excessively spread in a wet state and therefore a pattern having an irregular shape tends to be formed. In the case of a contact angle of greater than 60 degrees, when one droplet impacts the substrate P and comes into contact with the other droplet that has already been on the substrate P, one droplet is incorporated into the other droplet, making a concave 20 excessively large. One method for setting the contact angle in the range not less than 30 degrees nor more than 60 degrees as mentioned above is to adjust the surface tension of the etchant X1 (alkaline liquid) itself such that the contact angle of the etchant to the substrate is not less than 30 degrees nor more than 60 degrees. In order to adjust the surface tension, a minute amount of a fluorinated, silicone, or nonionic surface tension adjuster can be added to the etchant X1. Another method is to adjust the lyophobicity of the substrate P. Moreover, both methods may be combined with each other.

When the etchant X1 (alkaline liquid) is placed on the substrate P by a droplet discharge method, the concave 29 shown in FIG. 3C is formed due to the alkaline action in a portion of the substrate where the etchant is placed. The etchant placed is left at room temperature for 1 to 20 minutes, preferably 2 to 15 minutes, and more preferably 3 to 10 minutes so that the concave 29 is fully formed. Thereafter, the etchant X1 is cleaned and removed with a cleaning fluid. As the cleaning fluid, water or an organic solvent medium can be used. Many concaves 29 are formed on the surface of the substrate P in this manner. The concave 29 is a lyophilic portion and the surface of the substrate P except for the concave 29 remains lyophobic.

(Microlens Material Placing)

In step S4 of FIG. 4, a function liquid X2 (microlens material) as a lens material is discharged and placed in the concave 29 by using the droplet discharge device IJ as shown in FIG. 3D. In this case, a photopolymerizing resin liquid is used as the microlens material and the function liquid X2 using a monomer liquid is discharged. In addition, the droplet discharge is performed under the conditions of, for example, a droplet weight of 4 ng/dot and a droplet velocity (discharge velocity) of 5 to 7 m/sec. The atmosphere in which a droplet is discharged is preferably set at a temperature of 60° C. or less and a humidity of 80% or less. Thus, stable droplet discharge can be performed without clogging in discharge nozzles of the droplet discharge head 1. Thermosetting resin solutions may also be employed in addition to photopolymerizing resin solutions as the microlens material, and the form of the resin may be either polymer or monomer. If the monomer is in a liquid state, the monomer itself may be used instead of a solution containing the monomer. Polymer solutions that do not respond to light or heat may also be used.

The function liquid X2 discharged as the lens material is likely to be placed into the concave 29 since the concave is provided with lyophilicity, and this liquid is unlikely to get out of the concave 29 and is likely to remain in it since the substrate surface except for the concave is made lyophobic. The function liquid X2 (microlens material) as the lens material has high adhesion to the concave 29, and therefore becomes difficult to remove after cured.

(Microlens Material Curing)

In step S5 of FIG. 4, the function liquid X2 as the lens material (microlens material) is cured as shown in FIG. 3E. The function liquid X2 as the lens material (microlens material) is required to be cured for enhancing the mechanical and thermal strength as a lens. A thermal treatment and/or optical treatment is therefore applied to the substrate P after the discharging. Thus, the microlens 30 can be formed.

The thermal treatment and/or optical treatment is normally performed in an atmosphere, but may be performed in an atmosphere of inactive gas such as nitrogen, argon, or helium as required. The treatment conditions of the thermal treatment and/or optical treatment are suitably determined in consideration of boiling point of a solvent (vapor pressure), types and pressure of atmosphere gas, reaction temperature or reaction light exposure of a polymerization initiator, reaction temperature or reaction light exposure of cross-linking reaction, glass-transition temperature of oligomers and polymers, allowable temperature limit of base materials, thermal behaviors such as dispersibility and oxidation of fine particles, and the like.

In the optical treatment, the function liquid X2 as the lens material (microlens material) can be cured by using ultraviolet rays, far-ultraviolet rays, electron rays, X rays, or the like to form a lens; any type of rays is preferably 1 J/cm² or less, and more preferably 0.2 J/cm² or less for productivity improvement. The thermal treatment can be performed by using a hot plate, an electric furnace, or the like, and in addition by lamp annealing. The temperature of the thermal treatment is preferably 200° C. or less if it is equal to or less than the glass transition temperature of a cured material. If heating is performed at the temperature equal to or greater than the glass transition temperature, the lens shape might be altered to a low curvature shape because of overheating.

The following effects are obtained in the first embodiment.

(1) When the etchant X1 is placed on the substrate P, the concave 29 is formed on the base P by the action of the etchant X1. The function liquid X2 as the lens material is placed and cured in the concave 29, thereby forming the microlens 30. In this manner, the microlens 30 can be formed by a method using only a droplet discharge technique. Therefore, the exposure process and the development process are unnecessary, making operations efficient. A mask used in the exposure process and an etchant used in the development process become unnecessary.

### Second Embodiment

Microlens Manufacturing Method 2

The second embodiment will next be described. The second embodiment differs from the first embodiment described above in the following respects. Whereas the etchant X1 is placed on the substrate P for forming the concave 29 and alkali is used for the etchant X1 in the first embodiment, a bank material is applied onto the substrate P to form a bank material film on which an etchant X3 is placed for forming the concave 29 and a solvent medium is used for the etchant X3 in the second embodiment.

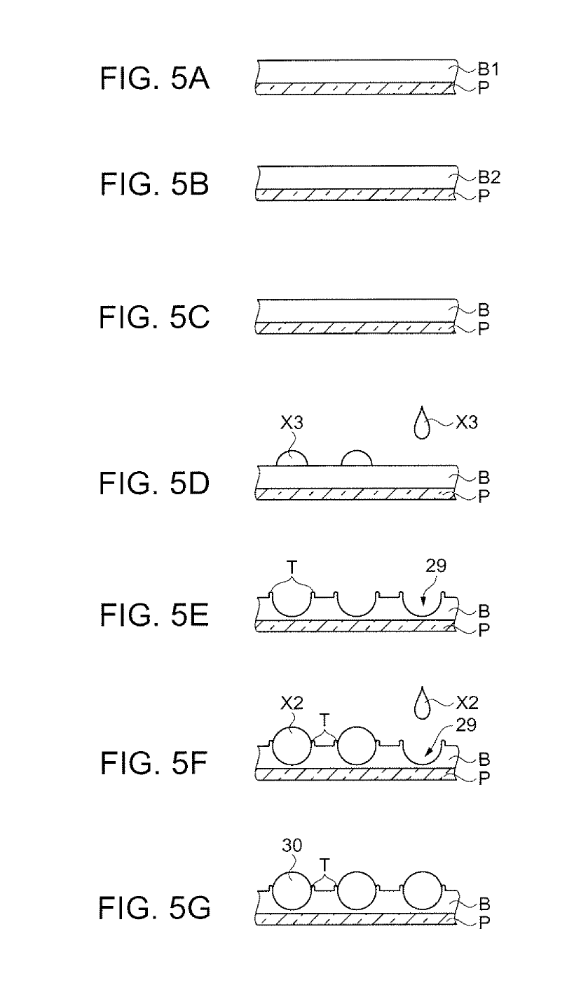

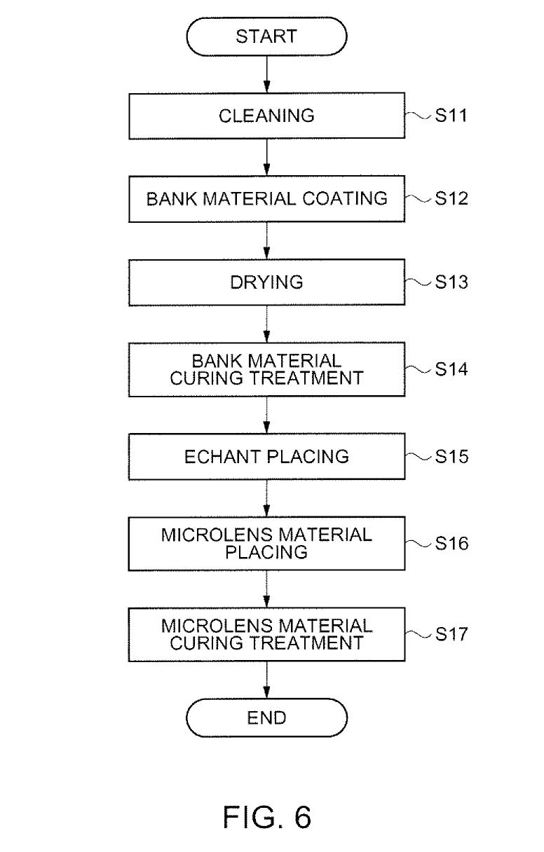

FIGS. 5A to 5G are sectional views for illustrating processes of manufacturing a microlens in the second embodiment. FIG. 6 is a schematic flow chart for illustrating procedures of the processes of manufacturing a microlens.

With reference to FIGS. 5A to 5G and FIG. 6, a method of manufacturing a microlens according to the invention will now be described. In addition, a method of forming a microlens in the second embodiment substantially consists of substrate cleaning, bank material coating, drying, bank material curing, etchant placing, microlens material placing, and microlens material curing. Steps S11, S16, and S17 of the second embodiment are the same as steps S1, S4, and S5 of the first embodiment, and therefore description on them will be omitted. Detailed description on the processes of steps S12, S13, S14, and S15 will be given below.

(Bank Material Placing)

In step S12 of FIG. 6, a bank material is discharged from the droplet discharge head 1 and placed on the substrate P by using the droplet discharge device IJ as shown in FIG. 5A. In this case, a photopolymerizing resin solution is used as the bank material and a photoresist solution OFPR (TOKYO OHKA KOGYO CO., LTD.) is discharged. In addition, the droplet discharge is performed under the conditions of, for example, a droplet weight of 4 ng/dot and a droplet velocity (discharge velocity) of 5 to 7 m/sec. The atmosphere in which a droplet is discharged is preferably set at a temperature of 60° C. or less and a humidity of 80% or less. Thus, stable droplet discharge can be performed without clogging in discharge nozzles of the droplet discharge head 1. Thermosetting resin solutions may also be employed in addition to photopolymerizing resin solutions as the bank material, and the form of the resin may be either polymer or monomer. If the monomer is in a liquid state, the monomer itself may be used instead of a solution containing the monomer. Polymer solutions that do not respond to light or heat may also be used. Thus, a bank material film B1 before being dried can be formed. In the bank material film B1, the material itself is lyophobic.

(Drying)

In step S13 of FIG. 6, the bank material film B1 placed on the substrate P is dried as shown in FIG. 5B. After a function liquid XO is discharged as the bank material, a dispersion medium is removed and drying is performed. Drying is preferably performed under heating or pressure reduction to increase the drying speed. Thus, a bank material film B2 is formed.

The heating can be performed usually by a hot plate, an electric furnace, or the like that heats the substrate, for example, and in addition by lamp annealing. Light sources used for lamp annealing are not particularly limited, but infrared lamps, xenon lamps, YAG lasers, argon lasers, carbon dioxide gas lasers, excimer lasers such as XeF, XeCl, XeBr, KrF, KrCl, ArF, and ArCl, and the like may be used as the light source. These light sources are generally used in the output range not less than 10 W nor more than 5000 W, but are sufficient for this embodiment in the range not less than 100 W nor more than 1000 W.

The pressure reduction can be performed by using a rotary pump, a vacuum pump, a turbo pump, or the like. The pressure reduction may use usual decompression drying machines in which the pump mentioned above is incorporated, and may be combined with heating. In these pressure reduction and drying processes, drying is achieved at the reduced pressure in a relatively low degree of vacuum of 10¹ to 10⁴ Pa. If the degree of vacuum is too high, the solvent is bumping, making it difficult to obtain an intended shape.

Bank Material Curing

In step S14 of FIG. 6, the dried bank material film B2 is cured, as shown in FIG. 5C. The bank material film B2 after being dried is required to be cured for enhancing the mechanical and thermal strength. In the case of a resin solution, a solvent is required to be completely removed for the same purpose. A thermal treatment is therefore applied to the substrate P after the discharging. Thus, the bank material film B2 can be formed. Although the thermal treatment is applied using OFPR in this embodiment, an optical treatment may be applied for curing, depending on the selected material.

The thermal treatment and/or optical treatment is normally performed in an atmosphere, but may be performed in an atmosphere of inactive gas such as nitrogen, argon, or helium as required. The treatment conditions of the thermal treatment and/or optical treatment are suitably determined in consideration of boiling point of a solvent (vapor pressure), types and pressure of atmosphere gas, reaction temperature or reaction light exposure of a polymerization initiator, reaction temperature or reaction light exposure of cross-linking reaction, glass-transition temperature of oligomers and polymers, allowable temperature limit of base materials, thermal behaviors such as dispersibility and oxidation of fine particles, and the like.

In the optical treatment, a bank can be cured and formed by using ultraviolet rays, far-ultraviolet rays, electron rays, X rays, or the like; any type of rays is preferably 1 J/cm² or less, and more preferably 0.2 J/cm² or less for productivity improvement. The thermal treatment can be performed by using a hot plate, an electric furnace, or the like, and in addition by lamp annealing. The temperature of the thermal treatment is preferably 200° C. or less if it is equal to or less than the glass transition temperature of a cured material.

(Etchant Placing)

In step S15 of FIG. 6, an etchant X3 as a first droplet composed of a solvent medium is placed on the substrate P as shown in FIG. 5D. In addition, a known method disclosed, for example, in JP-T-2003-518755, which is a related art example, is employed as the method of placing the etchant X3. Part of the etchant X3 discharged from the droplet discharge head 1 is repelled by the bank material film B, so that the diameter of the etchant attempts to be made smaller. If the diameter is made smaller, it becomes easy to densely form the concave 29.

An etchant that can dissolve the bank material film B is selected as the etchant X3. The etchant X3 gradually dissolves and penetrates the bank material film B until the concave 29 is formed. The dissolved matter is deposited on the side wall of the concave 29. A protrusion portion T shown in FIG. 5E is formed to be circular so as to prevent the function liquid X2 composed of a lens material from overflowing from the concave 29 when the liquid is placed in the concave. The type of the etchant X3 and the method of depositing the etchant are selected on the basis of the individual application.

An example of using a methanol solvent medium (containing 20 ng methanol per droplet) as the etchant X3 will be described. Methanol is selected as the solvent medium because it has a capability of easily dissolving OFPR, that is, it easily evaporates not to prevent the following processes and further has satisfactory wetting characteristics for OFPR. In this example, the droplet discharge head 1 of the droplet discharge device IJ is moved to a position where the concave 29 is to be formed for forming the concave 29. The required number of methanol droplets having a suitable size fall from the droplet discharge head 1 of the droplet discharge device IJ until the concave 29 is completed. The period between successive droplets is selected so as to correspond to a ratio at which methanol is dissolved in the bank material film B. It is preferable that each droplet completely or substantially completely evaporate and be dried before the next droplet is placed. In addition to methanol, solvent media such as isopropanol, ethanol, butanol, and actone may be used. In order to achieve a high throughput, it is desirable to complete the concave 29 by placing droplets of a single solvent medium. For a film having a thickness of 300 nm and a droplet having a volume of 30 pl and a diameter of 50 μm, the solubility in the solvent medium higher than 1 to 2% by weight per volume is needed to achieve the purpose. If formation of the concave 29 accompanying the use of the droplet of a single solvent medium is needed, a higher boiling point is further desired. In the case of OFPR, 1,2 dimethyl-2-imidazolidione (DMI) having a boiling point of 225° C. can be used.

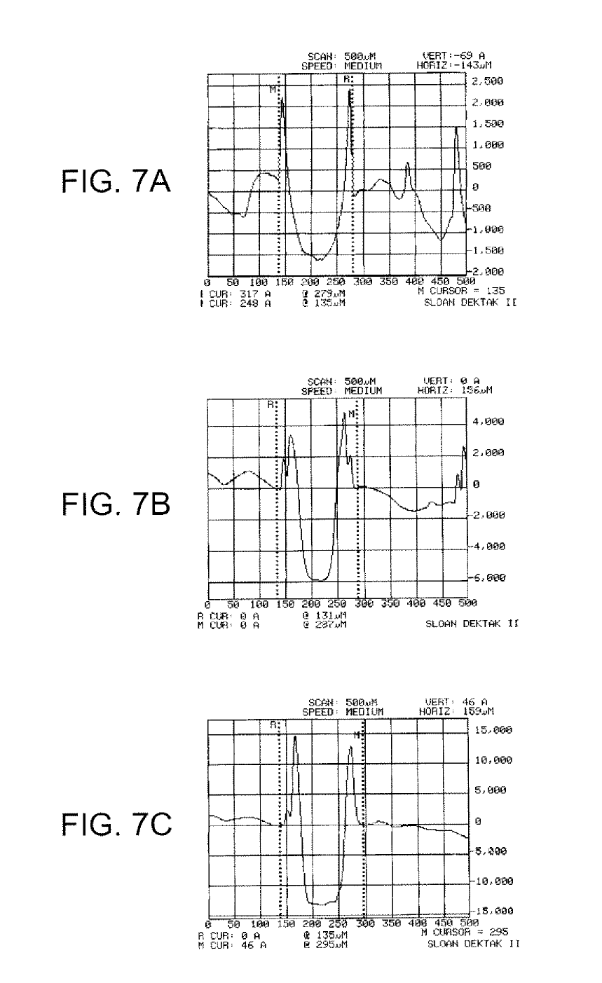

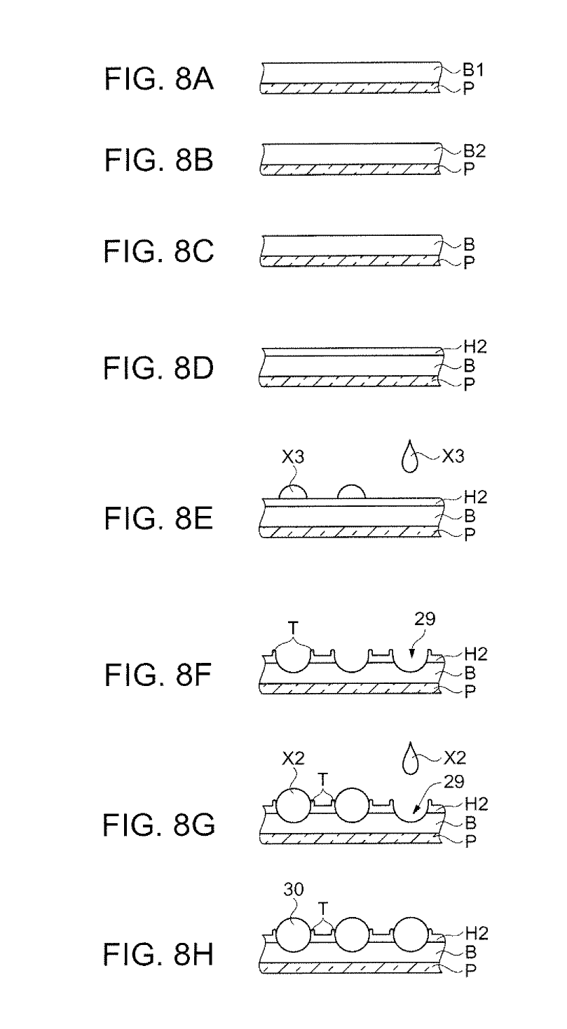

FIGS. 7A, 7B, and 7C show the concave 29 formed circularly by dissolution etching; FIG. 7A is a view illustrating the concave 29 after one droplet falls, FIG. 7B is a view illustrating the concave 29 after three droplets fall, and FIG. 7C is a view illustrating the concave 29 after eight droplets fall.

Measurement results of Dektak surface profile crossing the concave 29 formed after one droplet, three droplets, and eight droplets fall are shown in FIGS. 7A, 7B, and 7C, respectively. When several droplets successively fall on the same position, the concave 29 (crater) is opened in the PVP film. The depth of the concave 29 increases in accordance with the effects of the successive droplets. For example, when one droplet falls, the depth from the film surface is about 1.5 μm and the height of the protrusion portion T is about 2.5 μm. In other words, the whole depth of the concave 29 is 4 μm (see FIG. 7A). When three droplets fall, the depth from the film surface is about 6 μm and the height of the protrusion portion T is about 4 μm. In other words, the whole depth of the concave 29 is 10 μm (see FIG. 7B). When eight droplets fall, the depth from the film surface is about 13 μm and the height of the protrusion portion T is about 13 μm. In other words, the whole depth of the concave 29 is 26 μm (see FIG. 7C). Incidentally, the position of film surface is represented by the value of 0 on the vertical axis of the graph.

From the surface profile measurement results with Dektak, it is found that the substance is dissolved and is moved to the edge of the concave 29 by forming the concave 29 and the concave 29 remains after the solvent medium evaporates and is dried. Thus, the concave 29 is formed. It is desirable that the solvent medium slowly evaporate and be dried so as to form the uniform depth and shape of the concave 29. The concave 29 is formed circularly.

The mechanism to form the concave 29, that is, the movement of the substance to the side wall is considered to be similar to a known coffee-stain phenomenon that occurs when a contact line of a droplet containing a solute is pinned.

Effects other than the effects obtained in the first embodiment are obtained in the second embodiment as follows.

(2) By placing a methanol solvent medium as the etchant X3 on the bank material film B, the concave 29 is formed on the bank material film B due to the effect of the etchant X3. By drying the etchant X3 after etching, the concave 29 having the protrusion portion T at the outer periphery of the concave 29 is formed due to coffee-stain phenomenon. As a result, when the function liquid X2 as a lens material is placed, the function liquid X2 is unlikely to overflow and a large amount of the liquid accumulates, and therefore the microlens 30 with high curvature and aspect ratio can be formed by curing the function liquid X2. The protrusion T enables reduction of the etching depth and time of the concave 29 for forming a bank with the required height. Since the depth of the concave 29 and the height of the protrusion T can be adjusted by controlling a droplet, the height of the bank is easy to control.

Microlens Manufacturing Method 3

### Third Embodiment

The third embodiment will next be described. In the second embodiment described above, the etchant X3 is placed on the bank material film B to form the concave 29 in the bank material film B. However, the third embodiment differs from the second embodiment in that a lyophobic treatment is applied to the surface of the bank material film B, so that a lyophobic layer H2 is formed, and thereafter the etchant X3 is placed to form the concave 29. The etchant X3 is a solvent medium used in the second embodiment.

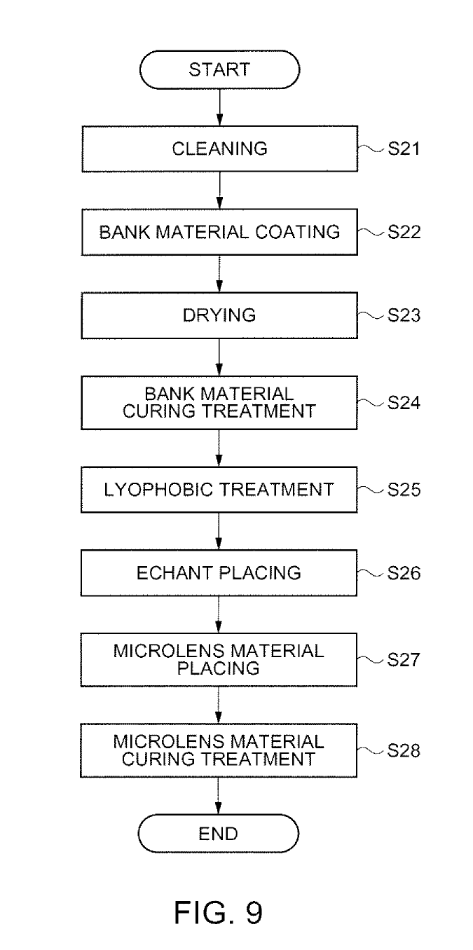

FIGS. 8A to 8H are sectional views for illustrating processes of manufacturing a microlens in the third embodiment. FIG. 9 is a schematic flow chart for illustrating procedures of the processes of manufacturing a microlens.

With reference to FIGS. 8A to 8H and FIG. 9, a method of manufacturing a microlens according to the invention will now be described. In addition, a method of forming a microlens in this embodiment substantially consists of substrate cleaning, bank material coating, drying, bank material curing, a lyophobic treatment, etchant placing, microlens material placing, and microlens material curing. This embodiment differs from the second embodiment in including the lyophobic treatment of making a bank material lyophobic. Steps S21, S22, S23, S24, S26, S27 and S28 of the third embodiment are the same as steps S11, S12, S13, S14, S15, S16 and S17 of the second embodiment, and therefore description on them will be omitted. Detailed description on the processes of step S25 will be given below.

(Lyophobic Treatment)

In step S25 of FIG. 9, a lyophobic treatment is applied to the bank surface of the cured bank material as shown in FIG. 8D. This process is a lyophobic treatment process of making the bank surface lyophobic. As the specific method of making the bank surface lyophobic, the same methods as those used for the surface treatment of the substrate P can be employed. A method of forming an organic thin film, a plasma treatment method, and the like can be employed. In the same manner as the lyophobic treatment of the substrate P, it is desirable to perform cleaning as the pretreatment process to perform the lyophobic treatment properly. For example, ultraviolet cleaning, ultraviolet/ozone cleaning, plasma cleaning, acid or alkali cleaning, or the like can be employed. If a bank material that has already had lyophobicity is used as the droplet, the lyophobic treatment can be omitted.

Specifically, a treatment is performed for the substrate P having the cured bank material film B formed thereon under the conditions of a plasma power of 700 W, an oxygen gas flow rate of 50 mL/min, a carrying rate of the substrate P relative to plasma discharge electrode of 1 mm/sec, and a substrate temperature of 30° C. to remove organic impurities and to form a hydroxyl group (—OH), thereby activating the surface. The substrate is further continuously treated under the conditions of plasma power of 700 W, carbon tetrafluoride gas flow rate of 70 mL/min, a carrying rate of substrate relative to plasma discharge electrode of 100 mm/sec, and a substrate temperature of 30° C. The static contact angle on the surface of the bank material film B after being treated is measured with water. The result is about 100 degrees. Thus, the lyophobic layer H2 is provided with lyophobicity.

Effects other than the effects (1) and (2) obtained in the first and second embodiments are obtained in the third embodiment as follows.

(3) When the lyophobic treatment to alter the wettability of the bank material film B is performed, for example, the lyophobic layer H2 is disposed on the bank material film B and the concave 29 is lyophilic, so that the function liquid X2 as the lens material tends to be repelled on the lyophobic layer H2 of the bank material film B and therefore attempts to stably remain in the concave 29. This can suppress the function liquid X2 as the lens material overflowing from the concave 29, thereby allowing formation of the microlens 30 with less variations.

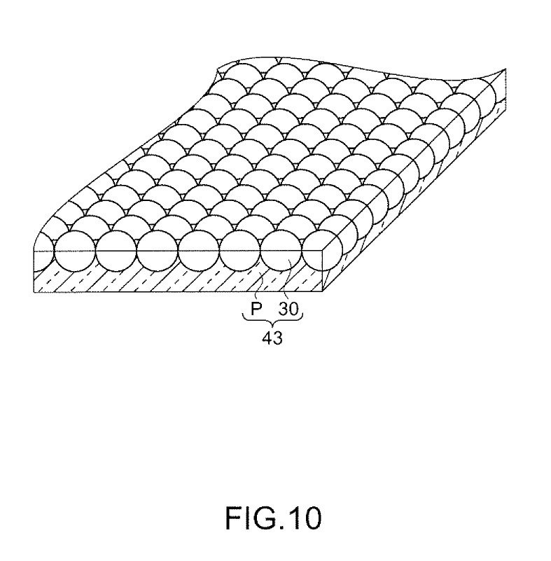

A diffusion board 43 as an optical element according to the invention to which the microlens 30 described above can be applied will next be described. FIG. 10 is a view showing the diffusion board 43. The diffusion board 43 includes the bank 29 as a first convex is formed on the substrate P, and further includes the microlens 30 formed on the bank. The material of the substrate P is glass, and the material of the microlens 30 is a photopolymerizing resin. Since the diffusion board 43 includes the microlens 30 that is low in price and has a good diffusion capability, it is possible to provide a diffusion board that is low in price and has a good diffusion capability.

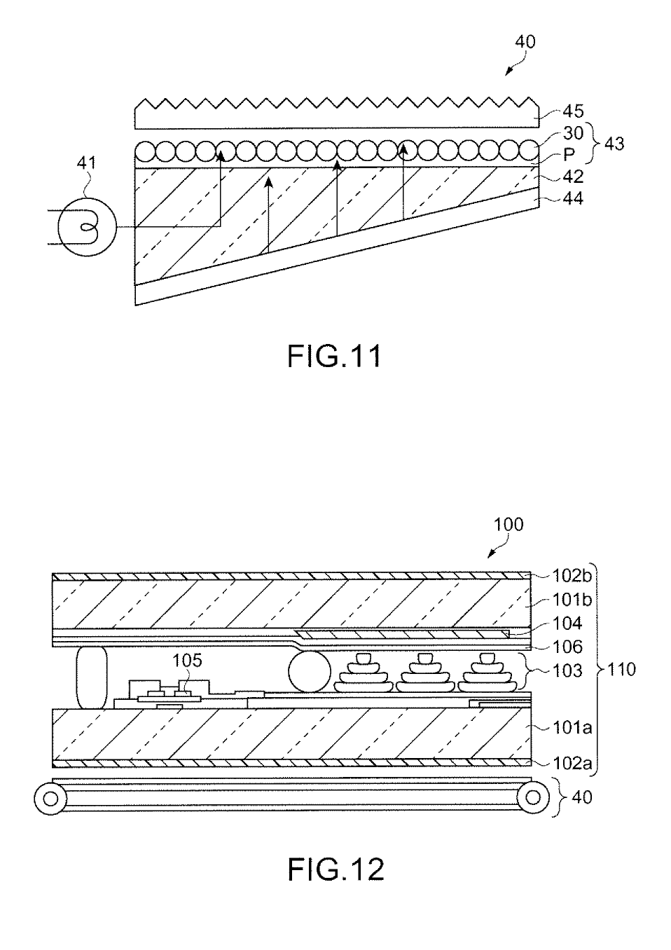

A backlight 40 according to the invention that uses the diffusion board 43 with the microlens 30 will next be described. FIG. 11 is a view showing the backlight 40. The backlight 40 includes a light source 41, a light guiding plate 42, the diffusion board 43, a reflector plate 44, a prism sheet 45, and the like. When the light from the light source 41 is incident on the light guiding plate 42, the incoming light passes through the light guiding plate 42 to be incident on the diffusion board 43. The light is diffused by the diffusion board 43, and passes through the prism sheet 45 onto a liquid crystal panel 110 (see FIG. 12). Leaked light is reflected by a reflector plate 44 into the light guiding plate 42. The microlens 30 is formed on the bank 29 as the first convex in the diffusion board 43 so that the light from the light guiding plate 42 can be fully diffused by the diffusion board 43. When passing through the prism sheet 45, the light diffused by the diffusion board 43 is controlled to be incident on a pixel of the liquid crystal panel 110 (see FIG. 12) at right angle. Since the backlight 40 includes the diffusion board 43 that is low in price and has a good diffusion capability, it is possible to provide the backlight 40 that is low in price and has a good diffusion capability.

A liquid crystal display device 100 as an electro-optical device according to the invention that uses the backlight 40 having the diffusion board 43 will next be described. FIG. 12 is a view showing the liquid crystal display device 100. The liquid crystal display device 100 includes the backlight 40, the liquid crystal panel 110, a driver LSI (not shown), and the like. The liquid crystal panel 110 includes two glass substrates 101a and 101b, two polarization plates 102a and 102b, liquid crystal 103, a color filter 104, a TFT, an orientation film 106, and the like. The polarization plates 102a and 102b are attached to the exterior surfaces of the glass substrates 101a and 101b. A TFT 105 and the like are formed on the interior surface of the glass substrate 101a. The color filter 104, the orientation film 106, and the like are formed on the interior surface of the glass substrate 101b. The liquid crystal 103 is disposed between the glass substrate 101a and the glass substrate 101b.

The glass substrates 101a and 101b are transparent substrates constituting the liquid crystal panel 110. The polarization plates 102a and 102b can transmit or absorb a particular polarization component. In the liquid crystal 103, the characteristics can be controlled by mixing several kinds of nematic liquid crystal. The color filter 104 is a resin film including dye and pigment that have three primary colors of R, G, and B. The TFT 105 is a driving switching element to drive the liquid crystal 103. The orientation film 106 is an organic thin film for orienting the liquid crystal 103, and a polyimide thin film is mainly used for the orientation film.

The light output from the backlight 40 passes through the polarization plate 102a and the glass substrate 101a, and further passes through the liquid crystal 103, the orientation film 106, and the color filter 104 subsequently, thereby enabling a predetermined image or picture to be displayed on the liquid crystal panel 110. The backlight 40 includes the diffusion board 43 with the microlens 30, and therefore can exhibit a good diffusion capability. The liquid crystal display device 100 including such the backlight 40 can provide images and pictures having a good contrast.

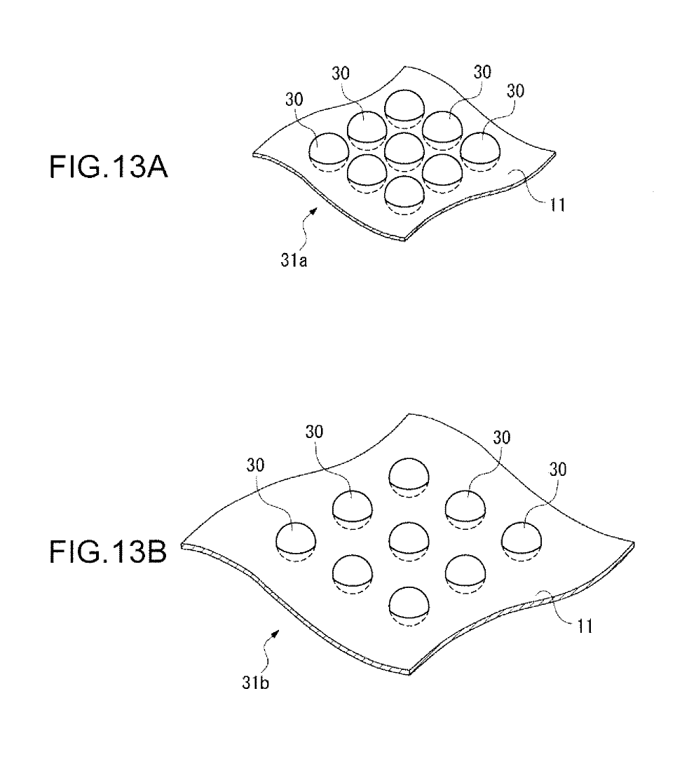

An example of the optical film 31 to which the microlens 30 obtained by the manufacturing method described above is applied will next be described. FIGS. 13A and 13B are schematic perspective views showing examples of the optical film 31. The optical film 31 is formed as the substrate 11 by using an optical transparent sheet or an optical transparent film as described above; optical films 31a and 31b of the invention are made by placing a large number of microlenses 30 lengthwise and crosswise on the substrate 11 as shown in FIGS. 13A and 13B.

In the optical film 31a shown in FIG. 13A, the microlenses 30 are arranged densely in the lengthwise and crosswise directions, that is, the microlenses 30 adjacent to each other are arranged closely so as to have the spacing sufficiently smaller than the diameter (external diameter of the bottom surface) of the microlens 30. This film is used as a lenticular film of the screen as described later. On the other hand, in the optical film 31b shown in FIG. 13B, the microlenses 30 are arranged sparsely as compared to the optical film 31a, that is, the microlenses 30 are arranged with a low density per unit area as compared to the optical film 31a. The optical film 31b is used as a scattering film of the screen as described later.

The optical films 31a and 31b include the above microlenses 30 requiring the reduced manufacturing cost and achieving high diffusion effects as described above, and therefore are low in price and have good diffusion capabilities. Since the microlenses 30 are densely arranged lengthwise and crosswise in the optical film 31a shown in FIG. 13A, the film exhibits a better diffusion capability and therefore is very good for use as a lenticular film of the screen. Since the microlenses 30 are sparsely arranged lengthwise and crosswise in the optical film 31a shown in FIG. 13B, if the film is used as a scattering film to scatter the light reflected after once entering the screen, the film excellently scatters the reflected light without excessively scattering the light that enters from the projection side. Since the bank 29 as the first convex is provided, the curvature or the aspect ratio of the microlens 30 is made higher due to the pinning effect of keeping a droplet in a step part, and therefore the microlens 30 having good lens characteristics are formed in the optical films 31a and 31b. Since the optical films 31a and 31b include the microlens 30 with reduced manufacturing cost, it is possible to provide the optical films 31a and 31b that are low in price and have good diffusion capabilities.

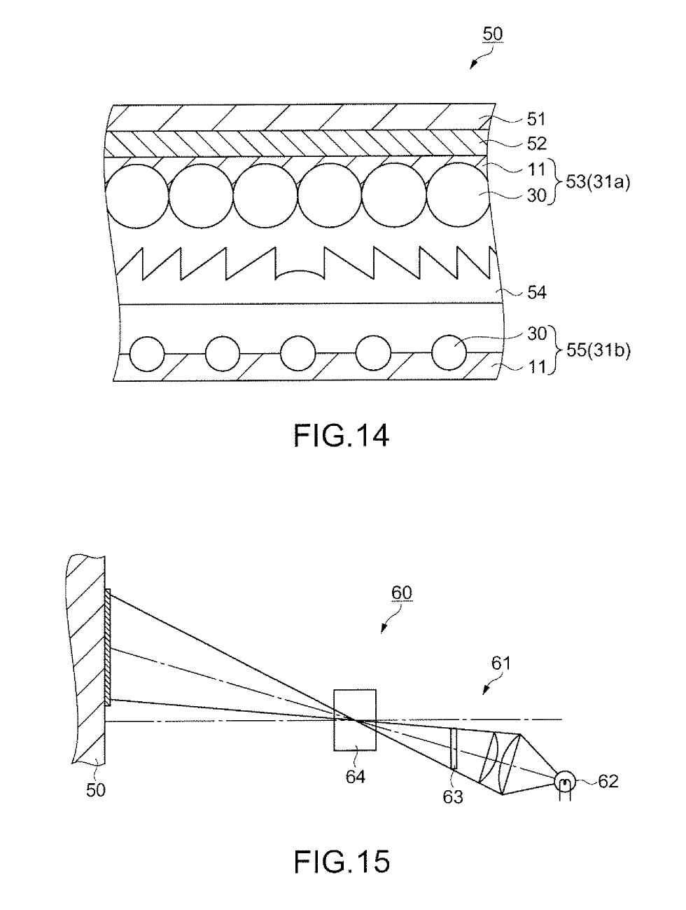

FIG. 14 is a view showing an example of the screen for projection 50 including these optical films 31a and 31b. In the screen for projection 50, a lenticular sheet 53 is attached through an adhesion layer 52 onto a film base material 51, and additionally a Fresnel lens 54, and a scattering film 55 are arranged in this order on the sheet.

The lenticular sheet 53 is composed of the optical film 31a shown in FIG. 13A such that a large number of microlenses 30 are densely arranged on an optical transparent sheet (substrate 11). The scattering film 55 is composed of the optical film 31b shown in FIG. 13B such that the microlenses 30 are sparsely arranged on the optical transparent sheet (substrate 11) as compared to the lenticular sheet 53.

The projection screen 50 as described above uses the above optical film 31a as the lenticular sheet 53 and the above optical film 31b as the scattering film 55, and therefore is low in price as compared to former screens using a cylindrical lens as the lenticular sheet. Since the optical film 31a used as the lenticular sheet 53 has a good diffusion capability, the quality of images projected on the projection screen 50 can be improved. Furthermore, since the optical film 31b used as the scattering film 55 has a good diffusion capability, the visibility of images projected on the projection screen 50 can be improved. A scattering film basically must transmit the light emitted from the projector. The scattering film 55 is formed such that the individual convex-shaped microlenses 30 have the low density per unit area as compared to that in the lenticular sheet, allowing a good transmission of the light emitted from the projector to be fully secured as described later.

The screen of the invention is not limited to the example shown in FIG. 14, and, for example, may use the above-described optical film 31a only as the lenticular sheet 53 or may use the above-described optical film 31b only as the scattering film 55. In these screens, use of the above-described optical film 31a as the lenticular sheet 53 can lower the price, and the good diffusion capability of the optical film used as the lenticular sheet can enhance the quality of images projected on the screen. Use of the above-described optical film 31b as the scattering film 55 can also lower the price. Furthermore, the optical film 31b constituting the scattering film 55 has a good diffusion capability. When the light transmitted through the scattering film 55 composed of the optical film 31b is reflected and is incident on the scattering film 55 once again (reflected), the incident light (reflection light) is scattered by the scattering film 55 and thereby the mirror reflection of the light can be suppressed, enhancing the visibility of images projected on the screen. Since the screen includes the lenticular sheet 53 (optical film 31a) and the scattering film 55 (optical film 31b) that are low in price and have good diffusion capabilities, it is possible to provide the projection screen 50 that is low in price and has a good contrast.

FIG. 15 is a view showing an example of a projector system 60 that includes the projection screen 50 shown in FIG. 14. The projector system 60 includes a projector 61 and the projection screen 50 described above. The projector 61 consists of a light source 62, a liquid crystal light valve 63 that is placed on the optical axis of the light emitted from the light source 62 to modulate the light from the light source 62, an imaging lens (imaging optics) 64 to produce an image of the light transmitted through the liquid crystal light valve 63. The means used in this example is not limited to the liquid crystal light valve, and any means may be used as long as it modulates light. For example, a means that modulates the light from a light source by driving a minute reflecting member (controlling the reflecting angle) may be used.

The projector system 60 uses the screen projection 50 shown in FIG. 14 as the screen, and therefore can improve the visibility of an image projected and enhance the quality of images projected on the projection screen 50. Furthermore, the scattering film 55 composed of the optical film 31b can fully secure a good transmission of the light emitted from the projector 61. Since the projector system includes the projection screen 50 that are low in price and have a high resolution, it is possible to provide the projector system 60 that is low in price and has a good contrast.

The screen used in the projector system 60 is not limited to the projection screen 50 shown in FIG. 14, and may be one using the optical film 31a only as the lenticular sheet 53 or may be one using the optical film 31b only as the scattering film 55, as described above.

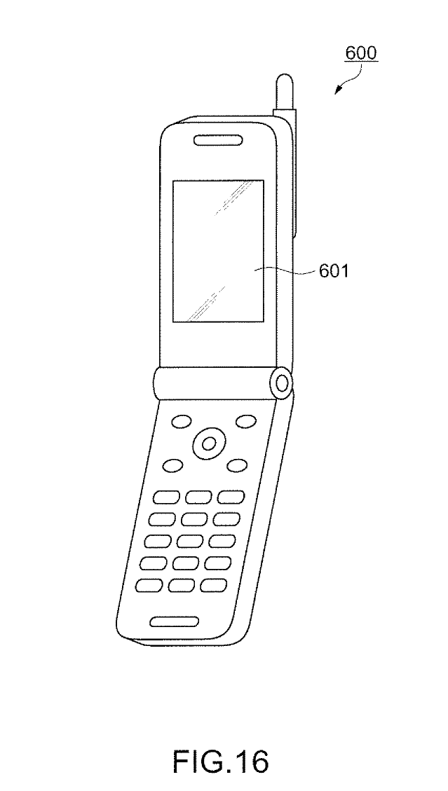

FIG. 16 is a view showing an example of a cellular phone 600 as an electronic apparatus including the liquid crystal display device 100 as the electro-optical device shown in FIG. 12. In FIG. 16, the cellular phone 600 and a liquid crystal display 601 with the liquid crystal display device 100 are shown. Since the cellular phone 600 includes the liquid crystal display device 100 that has the backlight 40 with the microlenses 30 in the above embodiments that are low-costed and have a good diffusion capability, it is possible to provide, for example, the cellular phone 600 as an electronic apparatus having a good display capability.

As described above, the present invention has been described with respect to preferred embodiments, but the invention is not limited to them, and includes modifications described below, which can be made in any other structures and shapes as long as they can attain the purpose of the invention.

(Modification 1) The lyophobic treatment is applied onto the substrate P to form the lyophobic layer H1 in the first embodiment described above, but the surface treatment is not limited to this. For example, the surface of the substrate P may be made lyophilic. This can increase the concave 29, thereby increasing the diameter of the microlens 30.

(Modification 2) The substrate P is made lyophobic and then the concave 29 is formed in the process of forming the concave 29 in the first embodiment described above, but the concave formation process is not limited to this. For example, a lyophobic treatment may be applied onto the substrate P after formation of the concave 29. Thus, the concave 29 is made lyophobic, and therefore the function liquid X2 as the microlens material that is dropped to the concave 29 is likely to be repelled and the function liquid X2 attempts to be made smaller, allowing the microlens of a smaller shape to be formed.

(Modification 3) The microlens 30 is used for the screen for projection and the projector system in the embodiments described above, but its use is not limited to them. For example, the microlens can also be used as optical parts provided for laser printer heads, optical coupling units of acceptance surfaces of solid-state image pickup device (CCD) and fiber optics, optical transmission devices, and the like.

What is claimed is:

1. A method of forming a microlens such that a convex microlens is formed on a base, the method comprising:
placing a first droplet composed of an etchant on the base and forming a concave on the base by etching;
placing a second droplet composed of a lens material on the concave; and
curing the second droplet to form the microlens.

2. A method of forming a microlens such that a convex microlens is formed on a base, the method comprising:
forming a film composed of a bank material on the base;
placing a first droplet composed of an etchant on the film and forming a concave by etching the film;
placing a second droplet composed of a lens material on the concave; and
curing the second droplet to form the microlens.

3. A method of forming a microlens such that a convex microlens is formed on a base, the method comprising:
forming a film composed of a bank material on the base;
performing a lyophobic treatment for changing wettability of the film;
placing a first droplet composed of an etchant on the film and forming a concave by etching the film;
placing a second droplet composed of a lens material on the concave; and
curing the second droplet to form the microlens.

4. The method of forming a microlens according to claim 1, further comprising drying the first droplet after forming the concave.

5. A microlens manufactured by the method of manufacturing a microlens according to claim 1.

6. An optical element comprising:
a base;
a convex microlens formed on the base; and
a concave formed by placing a first droplet composed of an etchant on the base and etching the base;
wherein the microlens is formed by curing a second droplet composed of a lens material placed on the concave.

7. An optical film comprising:
a base; and
a microlens according to claim 5 formed on the base;
wherein the base is composed of an optical transparent sheet or an optical transparent film.

8. A screen for projection comprising a scattering film to scatter light or a diffusion film to diffuse the light placed at a light-incident side or a light-output side, wherein the optical film according to claim 7 is used for at least one of the scattering film and the diffusion film.

9. A projector system comprising a screen and a projector, wherein the screen for projection according to claim 8 is provided as the screen.

10. A backlight comprising a light source, a light guiding plate, and a diffusion board, wherein the optical element according to claim 6 is provided as the diffusion board.

11. An electro-optical device comprising the backlight according to claim 10.

12. An electronic apparatus comprising the electro-optical device according to claim 11.
